(19) United States
(12) Patent Application Publication
(10) Pub. No.: US 2011/0011135 A1
(43) Pub. Date: Jan. 20, 2011

(54) METHOD OF MAKING A GLASS PREFORM

(75) Inventor: Tomohiro ISHIHARA, Yokohama-shi (JP)

Correspondence Address: DRINKER BIDDLE & REATH (DC), 1500 K STREET, N.W., SUITE 1100, WASHINGTON, DC, 20005-1209, US

(73) Assignee: SUMITOMO ELECTRIC INDUSTRIES, LTD., Osaka-shi (JP)

(21) Appl. No.: 12/835,299

(22) Filed: Jul. 13, 2010

(30) Foreign Application Priority Data
Jul. 15, 2009 (JP) 2009-166807

(51) Int. Cl. C03B 37/02

(52) U.S. Cl. 65/435

(57) ABSTRACT

The method that enables high yield production of a glass preform comprises an assembling step, a soot deposition step, a pulling step, a consolidation step, and a collapse step. In at least one traverse of the reciprocating movement during the soot deposition step, the relative transfer velocity of the base rod unit and the glass synthesizing burner in a second range is made slower than the relative transfer velocity of the base rod unit and the glass synthesizing burner in a first range, where the first range is a range extending from a boundary position to the tip portion of the starting mandrel and the second range is a range extending from the boundary position to a part of the tubular handle, the boundary position being a position that is 30 mm or more distanced from one end of the tubular handle to the direction of the tip portion of the starting mandrel.

### BACKGROUND OF THE INVENTION

1. Field of the Invention

The present invention relates to a method of making a glass preform for optical fiber.

2. Description of the Background Art

An optical fiber is formed by drawing one end of a substantially cylindrical glass preform while it is heated to soften. Also, the glass preform for the optical fiber is produced by a manufacturing method such as the OVD method, the MCVD method, or the like. PCT Application Japanese Translation Publication No. 2002-543026 (Patent document 1) discloses a method for manufacturing a glass preform by the OVD method.

The glass preform manufacturing method of Patent Document 1 intends to manufacture a glass preform for optical fiber with low water content. According to this manufacturing method, a glass soot body is formed by depositing fine glass particles around a starting mandrel and a tubular handle into which the starting mandrel is inserted (deposition process), and then the starting mandrel is pulled out from the glass soot body, whereby a glass soot body having an axially extending central hole is prepared. Subsequently, the glass soot body is dehydrated and consolidated by heating so that the central hole is occluded to form a transparent glass preform.

In the deposition process, the starting mandrel and a glass synthesizing burner are caused to conduct mutually relative reciprocating movement along the starting mandrel so that a glass soot body is formed by depositing fine glass particles around their outer circumferences over a range from the tip portion of the starting mandrel to a part of the tubular handle. In such case, the glass soot body occasionally breaks, resulting in low yield production of glass preforms.

### SUMMARY OF THE INVENTION

The object of the present invention is to provide a method that enables high yield production of glass preforms.

To achieve the object, the method of manufacturing a glass preform is provided, which comprises an assembling step, a soot deposition step, a pulling step, a consolidation step, and a collapse step. In the assembling step, a starting mandrel is inserted into a tubular handle and fixed such that the tip portion of the starting mandrel protrudes from one end of the tubular handle, and thereby a base rod unit is prepared. In the soot deposition step, the base rod unit and a glass synthesizing burner conduct mutually relative reciprocating movement along the starting mandrel, and fine glass particles are deposited around the outer circumference of the base rod unit over a range from the tip portion of the starting mandrel to a part of the tubular handle so that a glass soot body is formed. In the pulling step, the starting mandrel is pulled out from the tubular handle and the glass soot body. In the consolidation step, a consolidated glass pipe is prepared by heating the glass soot body after the pulling step. In the collapse step, a solid glass preform is prepared by decompressing the inside of the consolidated glass pipe and heating the consolidated glass pipe. In at least one traverse of the reciprocating movement during the soot deposition step, the relative transfer velocity of the base rod unit and the glass synthesizing burner in a second range is made slower than the relative transfer velocity of the base rod unit and the glass synthesizing burner in a first range. Here, the position that is 30 mm or more distanced from one end of the tubular handle to the direction of the tip portion of the starting mandrel is defined as a boundary position, and the first range is a range extending from the boundary position to the tip portion of the starting mandrel while the second range is a range extending from the boundary position to a part of the tubular handle.

Preferably, the minimum of the relative transfer velocity of the base rod unit and the glass synthesizing burner in the second range is 1 to 100 mm per minute. It is preferable that the above-mentioned at least one traverse be made from the first traverse to the tenth traverse or less in the reciprocating movement. Preferably, the above-mentioned at least one traverse is such that two or more traverses are conducted changing the boundary position between the first range and the second range, or two or more traverses are conducted altering the relative transfer velocity in the second range. It is preferable that the relative transfer velocity in the second range be lowest at the end of the tubular handle and gradually increase or decrease around the end of the tubular handle.

The glass preform manufacturing method according to the present invention enables high yield production of glass preforms.

### BRIEF DESCRIPTION OF THE DRAWING

FIG. 1 is a flow chart of the glass preform manufacturing method relating to an embodiment of the present invention.

FIG. 2 is a conceptional schematic diagram for explaining Assembling step of the glass preform manufacturing method in FIG. 1.

FIG. 3 is a conceptional schematic diagram for explaining Soot deposition step of the glass preform manufacturing method in FIG. 1.

FIG. 4 is a conceptional schematic diagram for explaining Pulling step of the glass preform manufacturing method in FIG. 1.

FIG. 5 is a conceptional schematic diagram for explaining Consolidation step of the glass preform manufacturing method in FIG. 1.

FIG. 6 is a conceptional schematic diagram for explaining Collapse step of the glass preform manufacturing method in FIG. 1.

FIG. 7 is a conceptional schematic diagram for further describing Soot deposition step S2 of the glass preform manufacturing method in FIG. 1.

FIG. 8 is a table summarizing the conditions and satisfactory production rate D percentage in each of Examples 1 to 6.

### DETAILED DESCRIPTION OF THE INVENTION

The above-mentioned features and other features, aspects, and advantages of the present invention will be better understood through the following description, appended claims, and accompanying drawings. In the explanation of the drawings, an identical mark is applied to like elements and an overlapping explanation will be omitted.

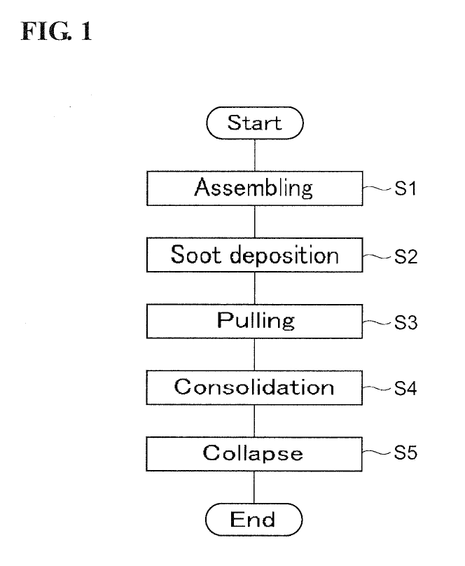

FIG. 1 is a flow chart of the glass preform manufacturing method relating to an embodiment of the present invention. According to the glass preform manufacturing method relating to an embodiment of the present invention, a glass preform is produced through Assembling step S1, Soot deposition step S2, Pulling step S3, Consolidation step S4, and Collapse step S5, in the enumerated order. The glass preform manufactured by this glass preform manufacturing method may be, for example, an optical fiber preform from which an optical fiber is produced by drawing as it is, or may be a core preform which is a core region of the optical fiber preform.

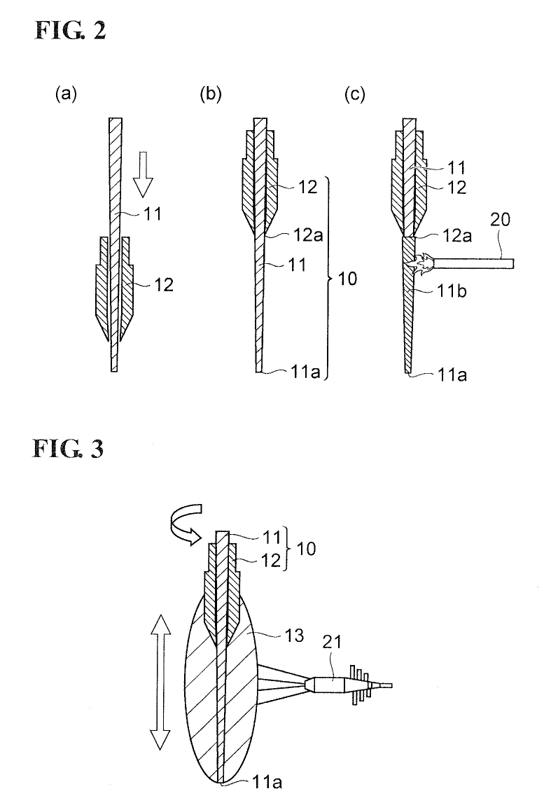

FIG. 2 is a conceptional schematic diagram for explaining Assembling step S1 of the glass preform manufacturing method in FIG. 1. In Assembling step S1, a starting mandrel 11 is inserted and fixed in a tubular handle 12 such that the tip portion 11a of the starting mandrel 11 protrudes from an end 12a of the tubular handle 12, and thereby a base rod unit 10 is prepared (regions (a) and (b) in FIG. 2). The starting mandrel 11 is made of a material such as alumina, glass, fire-resistant ceramics, or carbon, for example. The tubular handle 12 is made of silica glass. It is preferable that in the base rod unit 10, a carbon film 11b be formed, by a flame from a burner 20 using a city gas burner or an acetylene burner, around the outer circumferential surface of the starting mandrel 11 at the part that protrudes from an end 12a of the tubular handle 12 (region (c) in FIG. 2). During the process of forming the carbon film, the base rod unit 10 turns around the central axis of the starting mandrel 11, and a mutually relative reciprocating movement of the burner 20 and the base rod unit 10 is repeated along the starting mandrel 11.

FIG. 3 is a conceptional schematic diagram for explaining Soot deposition step S2 of the glass preform manufacturing method in FIG. 1. In Soot deposition step S2, the base rod unit 10 is caused to turn around the central axis of the starting mandrel 11. Also, the base rod unit 10 and a glass synthesizing burner 21, which is arranged at the side of the base rod unit 10 and forms an oxyhydrogen flame, repeats mutually relative reciprocating movement along the starting mandrel 11. Then, fine glass particles are deposited by the OVD method around the outer circumference of the base rod unit 10 over a range from the tip portion 11a of the starting mandrel 11 to a part of the tubular handle 12, and thereby a glass soot body 13 is prepared.

In Soot deposition step S2, the flow rate of raw materials supplied to the glass synthesizing burner 21 is changed for every traverse (from the tip portion 11a of the starting mandrel 11 to a part of the tubular handle 12, or from a part of the tubular handle 12 to the tip portion 11a of the starting mandrel 11). Thus, the fine glass particles that are deposited around the outer circumference of the starting mandrel 11 have an intended distribution of compositions in a radial direction (that is, a refractive index profile in a radial direction of a glass preform or an optical fiber produced later).

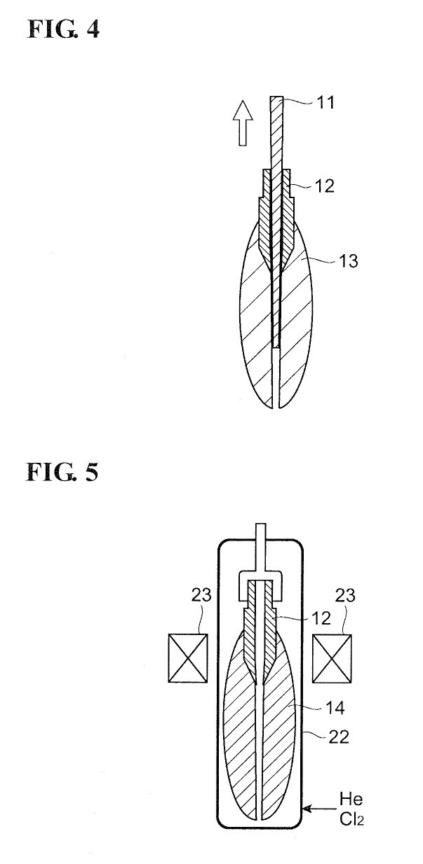

FIG. 4 is a conceptional schematic diagram for explaining Pulling step S3 of the glass preform manufacturing method in FIG. 1. In Pulling step S3, the starting mandrel 11 is pulled out from the tubular handle 12 and the glass soot body 13. At that time, the tubular handle 12 and the glass soot body 13 remain fixed together as they are. If a carbon film is formed beforehand around the outer circumference of the starting mandrel 11 at a part which protrudes from the end 12a of the tubular handle 12 during Assembling step S1, it is possible to prevent the inner wall surface of the central hole of the glass soot body 13 from being damaged or cracked when the starting mandrel 11 is pulled out in Pulling step S3.

FIG. 5 is a conceptional schematic diagram for explaining Consolidation step S4 of the glass preform manufacturing method in FIG. 1. In Consolidation step S4, the glass soot body 13 which is integral with the tubular handle 12 is altogether put in a heating furnace 22 into which He gas and Cl₂ gas are introduced, and they are heated by a heater 23. Thus, a consolidated glass pipe 14 is prepared.

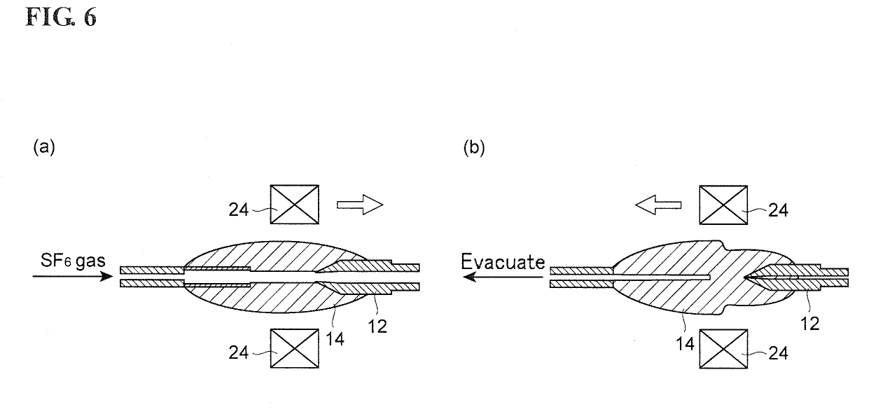

FIG. 6 is a conceptional schematic diagram for explaining Collapse step S5 of the glass preform manufacturing method in FIG. 1. In Collapse step S5, the consolidated glass pipe 14 is placed in the heating furnace, and heated by the heater 24 while it is turned as SF₆ gas is introduced into the central hole, so that the inner wall surface of the central hole is etched with vapor-phase etching (region (a) in FIG. 6). Subsequently, the inside of the consolidated glass pipe 14 is decompressed, and it is heated by the heater 24, whereby it is collapsed (region (b) in FIG. 6). Thus, a solid glass preform is produced.

The transparent glass preform thus prepared is further subjected to a process of forming a cladding layer on its outer surface, followed by the consolidation or like process thereof, so that a preform is completed. Furthermore, an optical fiber is manufactured by drawing while heating and softening an end of such preform.

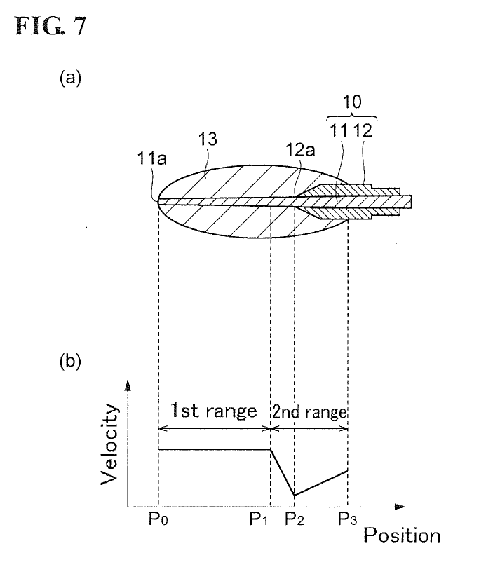

FIG. 7 is a conceptional schematic diagram for further describing Soot deposition step S2 of the glass preform manufacturing method in FIG. 1. In FIG. 7, the region (a) is a sectional view including the axis of the starting mandrel 11, and the region (b) is a graph showing relative transfer velocity of the base rod unit 10 and the glass synthesizing burner 21 for each position on the axis of the starting mandrel 11 and the tube handle 12. In Soot deposition step S2, the relative transfer velocity of the base rod unit 10 and the glass synthesizing burner 21 is designed to differ at a position P₁ where the distance from the end 12a (position P₂) of the tubular handle 12 to the direction of the tip portion 11a (position P₀) of the starting mandrel 11 is equal to or more than 30 mm. That is, in at least one traverse of the reciprocating movement during Soot deposition step S2, the transfer velocity for depositing fine glass particles in a range from a position P₁ to a position P₃ on the tubular handle 12 (second range) is made slower than the transfer velocity for depositing fine glass particles in a range extending from the position P₁ to the position P₀ (first range). For example, the transfer velocity in the first range is designed to be 500 mm to 1500 mm per minute, and the minimum of the transfer velocity in the second range is designed to be 1 mm to 100 mm per minute.

When the transfer velocity in the second range is set to the same as the transfer velocity in the first range, there are cases in which the glass soot body 13 cracks at the position P₂, and therefore, the yield of glass preform production becomes poor. Such crack might be caused due to the existence of difference in height level at the end 12a of the tubular handle 12. However, according to the present embodiment, the occurrence of such crack that starts from the position P₂ can be reduced since fine glass particles are deposited so as to make up for the height level difference at the end 12a of the tubular handle 12 by setting the transfer velocity in the second range to be lower than the transfer velocity in the first range. Therefore, the glass preform can be manufactured with high yield.

Generally, the traverse in the mutually relative reciprocating movement of the base rod unit and the glass synthesizing burner in the soot deposition step is performed about 1000 times. The traverses in Soot deposition step S2 are not all required to be conducted such that the transfer velocity in the second range is lower than the transfer velocity in the first range. If the traverse in which the transfer velocity is lower in the second range is conducted too many times, it would be rather undesirable because the problem of crack will arise at the part where the transfer velocity is so low as to cause fine glass particles become solid (high density), thereby generating density differences of fine glass particles near the boundary between a high-velocity traverse part and a low-velocity traverse part.

To prevent the occurrence of such a density difference, it is preferable that the number of traverse in which the transfer velocity in the second range is lower than the transfer velocity in the first range be limited to a scope from the first traverse to the tenth traverse or less. Also, for decreasing the occurrence of the density difference, it would be preferable to conduct traverses twice or more, changing the boundary position between the first range and the second range, or to conduct traverses twice or more, altering the relative transfer velocity in the second range. Also, it is preferable that the relative transfer velocity in the second range be lowest at the end 12a (position P₂) of the tubular handle 12, increasing or decreasing gradually around the end 12a of the tubular handle 12, as shown in the region (b) of FIG. 7.

### Examples 1 to 6

In Examples 1 to 6, glass preforms which are to be processed into cores of graded-index optical fibers are prepared. Soot deposition step S2 is performed using OVD equipment, a starting mandrel 11 made of alumina having a length of 1200 mm and an outer diameter of 9 to 10 mm, a tubular handle 12 made of silica glass having a length of 600 mm, an outer diameter of 20 to 40 mm, and an inner diameter of 9.8 to 21 mm. The material gas to be supplied to each of the glass synthesizing burner 21 is SiCl₄ (charged quantity 1 to 3 SLM) and GeCl₄ (charged quantity 0.0 to 0.3 SLM).

There is a height level difference of about 0.5 mm generated at the end 12a (position P₂) of the tubular handle 12. The range in a length of 80 mm to 145 mm including the position P₂ is defined as the second range, and the transfer velocity in the second range (P₁ to P₃) is made lower than the transfer velocity in the first range (P₀ to P₁). The transfer velocity in the first range (P₀ to P₁) is 500 mm to 1500 mm per minute.

After Soot deposition step S2 as described above, Collapse step S5 is performed through Pulling step S3 and Consolidation step S4. In collapse step S5, a consolidated glass pipe 14 which is placed in a heating furnace is turned at 30 r/min, and is heated to a temperature of 1900° C. to 2200° C. by the heating furnace (heater) which moves in a longitudinal direction of the consolidated glass pipe 14 at a speed of 20 mm/min. In such case, SF₆ gas of 50 to 100 seem is supplied into the central hole of the consolidated glass pipe 14, and the inner wall surface of the central hole of the consolidated glass pipe 14 is etched with the vapor-phase etching. Subsequently, the inside of the central hole of the consolidated glass pipe 14 is decompressed to 10 kPa, and collapsed at the same temperature as that of the etching, so that a glass preform is manufactured.

The glass preform prepared in this way is elongated to have a desired diameter, and a jacket glass is formed around the outer circumference by the OVD method, whereby a glass preform for an optical fiber is produced. The glass preform for an optical fiber is drawn so that a graded-index multi-mode fiber is manufactured.

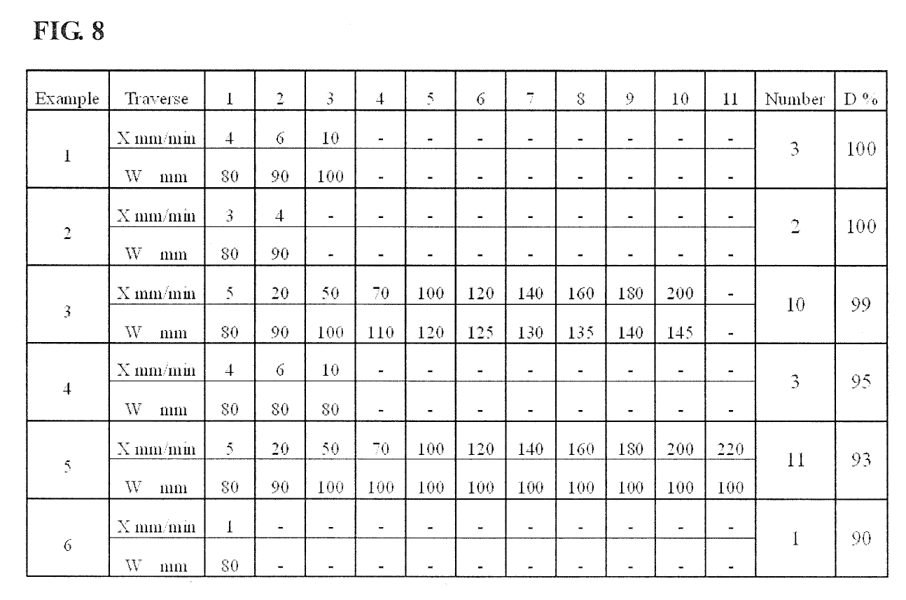

FIG. 8 is a table summarizing the conditions (the number of times N of traverses where the transfer velocity is made lower in the second range than in the first range; the transfer velocity X (mm/min) at the position P₂ where the velocity is the lowest in the second range; and the length W (mm) of the second range), and satisfactory production percentage D (%) in each of Examples 1 to 6. In all of Examples 1 to 6, the distance between the position P₁ and the position P₂ is made equal to or more than 30 mm. In all of Examples 1 to 6, the satisfactory production percentage D of the glass soot body is 90% or more.

As can be seen from the conditions in each of Examples 1 to 6 and satisfactory production percentages D, the satisfactory production percentage D decreases according to the increase in the number of times N of traverses where the velocity is lower in the second range than in the first range. This is because when the number of times N is large, the fine glass particles becomes solid (high density) at the part where the velocity is made lower. Therefore, it is preferable to make the number of times N equal to or less than 10, and also it is preferable to alter the second range from traverse to traverse. It is also preferable to change the relative transfer velocity in the second range for each traverse. In a comparative example where the transfer velocity in the second range (P₁ to P₃) and the transfer velocity in the first range (P₀ to P₁) are the same value of 500 mm/min, the satisfactory production percentage D of the glass soot body is 80%, failing to make stable production of acceptable glass preforms.

While this invention has been described in connection with what is presently considered to be the most practical and preferred embodiments, the invention is not limited to the disclosed embodiments, but on the contrary, is intended to cover various modifications and equivalent arrangements included within the scope of the appended claims.

1. A method of manufacturing a glass preform, comprising:
an assembling step for preparing a base rod unit such that a starting mandrel is inserted into a tubular handle and fixed so that the tip portion of the starting mandrel protrudes from one end of the tubular handle;
a soot deposition step for forming a glass soot body by causing the base rod unit and a glass synthesizing burner to conduct mutually relative reciprocating movement along the starting mandrel and depositing fine glass particles around the outer circumference of the base rod unit over a range from the tip portion of the starting mandrel to a part of the tubular handle;
a pulling step for pulling out the starting mandrel from the tubular handle and the glass soot body;
a consolidation step for preparing a consolidated glass pipe by heating the glass soot body after the pulling step; and
a collapse step for preparing a solid glass preform by decompressing the inside of the consolidated glass pipe and heating the consolidated glass pipe, wherein in at least one traverse of the reciprocating movement during the soot deposition step, the relative transfer velocity of the base rod unit and the glass synthesizing burner in a second range is made slower than the relative transfer velocity of the base rod unit and the glass synthesizing burner in a first range, the first range being a range extending from a boundary position to the tip portion of the starting mandrel, the second range being a range extending from the boundary position to a part of the tubular handle, where the boundary position is defined as a position that is 30 mm or more distanced from one end of the tubular handle to the direction of the tip portion of the starting mandrel.

2. A method of manufacturing glass preform as set forth in claim 1, wherein during the soot deposition step the minimum of the relative transfer velocity of the base rod unit and the glass synthesizing burner in the second range is 1 to 100 mm per minute.

3. A method of manufacturing glass preform as set forth in claim 1, wherein during the soot deposition step the said at least one traverse is made from the first traverse to the tenth traverse or less in the reciprocating movement.

4. A method of manufacturing glass preform as set forth in claim 1, wherein during the soot deposition step, the said at least one traverse is such that two or more traverses are conducted changing the boundary position between the first range and the second range.

5. A method of manufacturing glass preform as set forth in claim 1, wherein during the soot deposition step, the said at least one traverse is such that two or more traverses are conducted altering the relative transfer velocity in the second range.

6. A method of manufacturing glass preform as set forth in claim 1, wherein during the soot deposition step, the relative transfer velocity in the second range is lowest at the end of the tubular handle and gradually increases or decreases around the end of the tubular handle.
